(19) United States
(12) Patent Application Publication
(10) Pub. No.: US 2004/0052390 A1
(43) Pub. Date: Mar. 18, 2004

(54) Method and apparatus for programming a hearing device

(76) Inventors: Nelson Morales, Lakeville, MN (US); Jeffrey F. Larson, Rogers, MN (US); Brian L. Fideler, Jordan, MN (US)

Correspondence Address: SCHWEGMAN, LUNDBERG, WOESSNER & KLUTH, P.A., P.O. BOX 2938, MINNEAPOLIS, MN, 55402, US

(21) Appl. No.: 10/243,991

(22) Filed: Sep. 12, 2002

(51) Int. Cl. H04R 25/00

(52) U.S. Cl. 381/323; 381/312; 381/322

(57) ABSTRACT

An interface actuator is shown that guides a data transmission line to a programming interface only when the interface actuator is in a certain desired actuation state. Incorrect insertion of the data transmission line is substantially prohibited, and potential damage to the data transmission line is minimized. Further, in one embodiment, after the data transmission line has been guided into place, programming can be performed while the battery is in place.

### FIELD OF THE INVENTION

The invention generally relates to hearing aids. Specifically, the invention relates to externally programmable hearing aids.

### BACKGROUND

Devices that amplify sound or in other ways aid in the hearing process are used by ever increasing numbers of people. These devices, or hearing aids, typically include operational circuitry and a power source such as a battery. In many designs of hearing aids, the operational circuitry includes a number of complex functions such as frequency tuning ability that can be adjusted to individual users. Functions such as these must be programmed or adjusted depending on individual requirements.

Programming of functions such as frequency tuning is typically performed by interfacing with an external programming device and entering programming data into the hearing aid operational circuitry. In order to interface with an external programming device, the hearing aid typically includes a programming interface. During programming, an external data transmission line is inserted into the programming interface of the hearing aid, and the required programming instruction data is transmitted from the external programming device, through the data transmission line and into the hearing aid.

After programming, the data transmission line is removed from the programming interface of the hearing aid. The programming instruction data is then used by the operational circuitry to individually adjust incoming sounds to the requirements of the user.

One problem with external programming as described above is that data transmission lines must be small to interface with increasingly small hearing aids and their associated programming interfaces. The transmission lines can be fragile, and inserting them into programming interfaces can be difficult given the small scale of the operation. There is also a constant need in manufacturing products such as hearing aids to reduce manufacturing costs, and increase reliability.

One need in the industry is therefore a programming interface for a hearing aid that provides easier, more reliable operation when inserting a transmission line and subsequently programming a hearing aid. Another need is a device and method that is inexpensive to manufacture and more reliable than current designs.

### SUMMARY

The above mentioned problems with inserting transmission lines and programming hearing aids are addressed by the present invention and will be understood by reading and studying the following specification. Systems, devices and methods are provided for improved inserting of transmission lines and programming hearing aids.

A programming interface for a hearing aid is shown. In one embodiment, the programming interface includes at least one interface contact. The programming interface also includes an interface actuator that is movable through a range of motion. The range of motion includes a first state, wherein the interface actuator substantially prohibits insertion of a programming data transmission line in the first state. The range of motion also includes a second state, wherein the interface actuator guides the programming data transmission line to the interface contact in the second state.

A method for programming a hearing aid is also shown. The method includes locating a programming interface on the hearing aid, and actuating an interface actuator from a first state that substantially prohibits insertion of a programming data transmission line, to a second state that guides the programming data transmission line to the programming interface. The method for programming also includes inserting the programming data transmission line into the programming interface. The method also includes transmitting data to the hearing aid through the data transmission line.

A method of forming a programming interface for a hearing aid is also shown, including forming at least one interface contact. The method includes coupling an interface actuator adjacent to the interface contact, the interface actuator being switchable in a range of motion. The range of motion includes a first state, wherein the interface actuator substantially prohibits insertion of a programming data transmission line in the first state. The range of motion also includes a second state, wherein the interface actuator guides the programming data transmission line to the interface contact in the second state.

These and other embodiments, aspects, advantages, and features of the present invention will be set forth in part in the description which follows, and in part will become apparent to those skilled in the art by reference to the following description of the invention and referenced drawings or by practice of the invention. The aspects, advantages, and features of the invention are realized and attained by means of the instrumentalities, procedures, and combinations particularly pointed out in the appended claims.

### BRIEF DESCRIPTION OF THE DRAWINGS

FIG. 1A shows an isometric view of one embodiment of a hearing aid.

FIG. 1B shows an isometric view of a top portion of the hearing aid in FIG. 1A.

FIG. 1C shows a cut away isometric view of the hearing aid in FIG. 1A.

FIG. 2A shows a cross section view of a portion of the hearing aid in FIG. 1A as indicated by line 2-2.

FIG. 2B shows another cross section of a portion of one embodiment of a hearing aid.

FIG. 2C shows another cross section of a portion of one embodiment of a hearing aid.

FIG. 2D shows another cross section of a portion of one embodiment of a hearing aid.

FIG. 2E shows another cross section of a portion of one embodiment of a hearing aid.

### DETAILED DESCRIPTION

In the following detailed description of the invention, reference is made to the accompanying drawings which form a part hereof, and in which is shown, by way of illustration, specific embodiments in which the invention may be practiced. In the drawings, like numerals describe substantially similar components throughout the several views. These embodiments are described in sufficient detail to enable those skilled in the art to practice the invention. Other embodiments may be utilized and structural, logical, and electrical changes may be made without departing from the scope of the present invention.

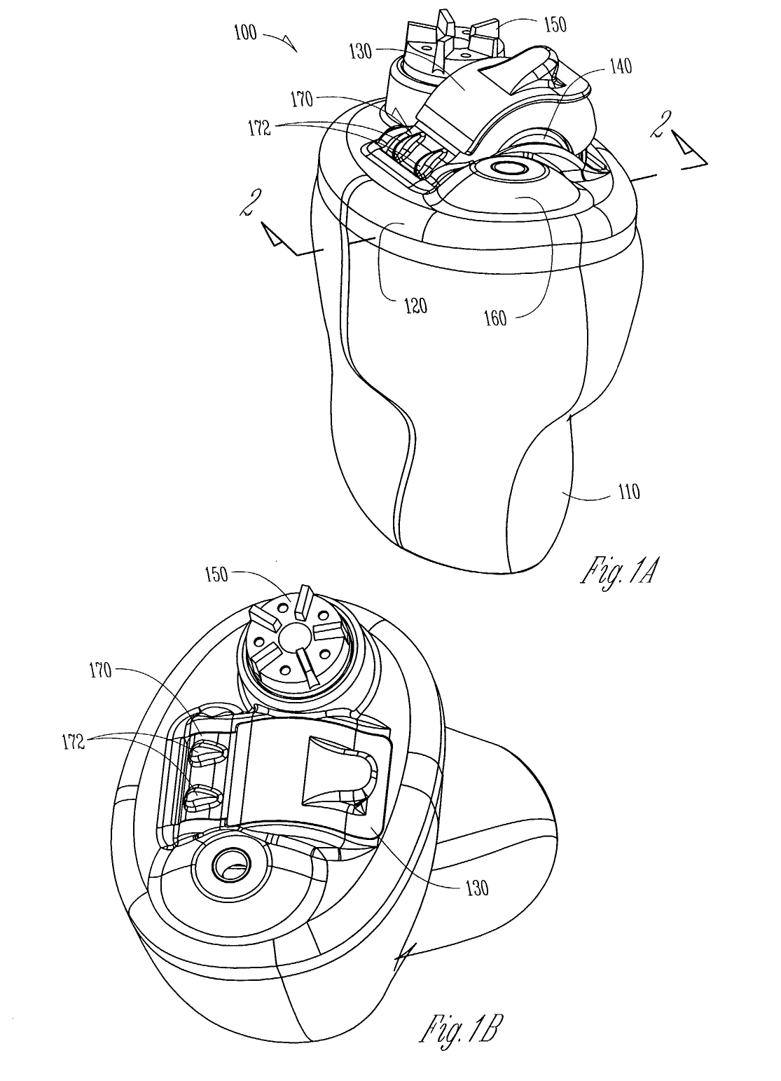

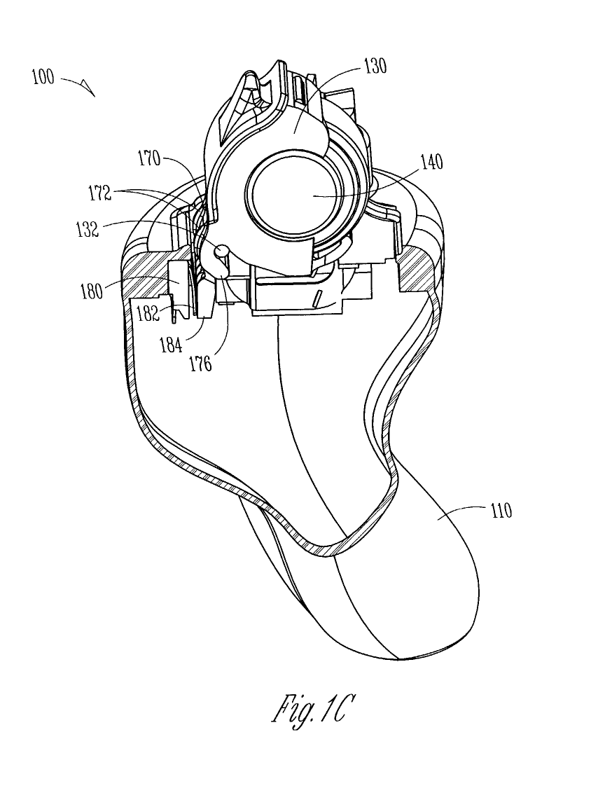

FIG. 1A illustrates one embodiment of a hearing aid 100. A body portion 110 is included which substantially houses operational circuitry (not shown). A cover portion 120 is shown coupled to the body portion 110. Included on the cover portion 120 are a number of elements. A battery door 130 is shown, with a battery 140. A volume control 150 is shown adjacent to the battery door 130. A sound detector 160 such as a microphone is further shown on the cover portion 120.

One skilled in the art, having the benefit of the present disclosure, will appreciate that other embodiments of the hearing aid 100 are also within the scope of the invention. Other embodiments of hearing aids include, but are not limited to, a single unit, without a separate body portion and cover portion. Other embodiments of hearing aids include additional user controls in addition to the volume control. Other embodiments do not include user controls. The hearing aid 100 shown in FIG. 1A is designed to fit substantially within a user's ear to be hidden from view. The present invention is not so limited. Other varieties of hearing aids, such as behind the ear models, etc. are also within the scope of the present invention.

The hearing aid 100 of FIG. 1A also includes an interface actuator 170. In one embodiment, the interface actuator is attached to a portion of the battery door 130. In one embodiment, the interface actuator is integrally molded with the battery door 130. The interface actuator, in one embodiment, includes a first portion 172. In one embodiment, the first portion includes an arcuate lobe. In one embodiment, the first portion includes a number of arcuate lobes. The embodiment illustrated in FIG. 1B shows a pair of arcuate lobes that serve as the first portion 172. The function of the first portion 172 are explained in more detail below.

FIG. 1C shows a cross section of hearing aid 100 along line 2-2 from FIG. 1A. The interface actuator 170 in the Figure is shown attached to a side of the battery door 130 adjacent to a door pivot 132. The interface actuator 170 is also adjacent to a programming interface 180. The programming interface includes a back plate 184, and at least one data contact 182. In one embodiment, the programming interface includes four data contacts. In one embodiment, the data contacts receive electrical data signals, although other embodiments may include alternate signal carriers such as fiber optic, etc. In one embodiment, the data contacts include metal spring contacts, such as copper, that include a spring force to maintain electrical contact with an external data transmission line. The external data transmission line is not shown in this Figure but will be illustrated in subsequent Figures.

FIG. 1C further illustrates the first portion 172 as a pair of arcuate lobes. FIG. 1C further shows a second portion 176. In one embodiment, the second portion includes an arcuate lobe. In one embodiment the arcuate lobe of the second portion includes a cam lobe. In one embodiment, the second portion includes a number of arcuate lobes. In the embodiment shown in FIG. 1C, the second portion 176 is attached to the battery door 130 in such a way as the second portion 176 additionally serves as part of a hinge around door pivot 132. In one embodiment, the second portion 176 and the first portion 172 are integrally molded with the battery door 130.

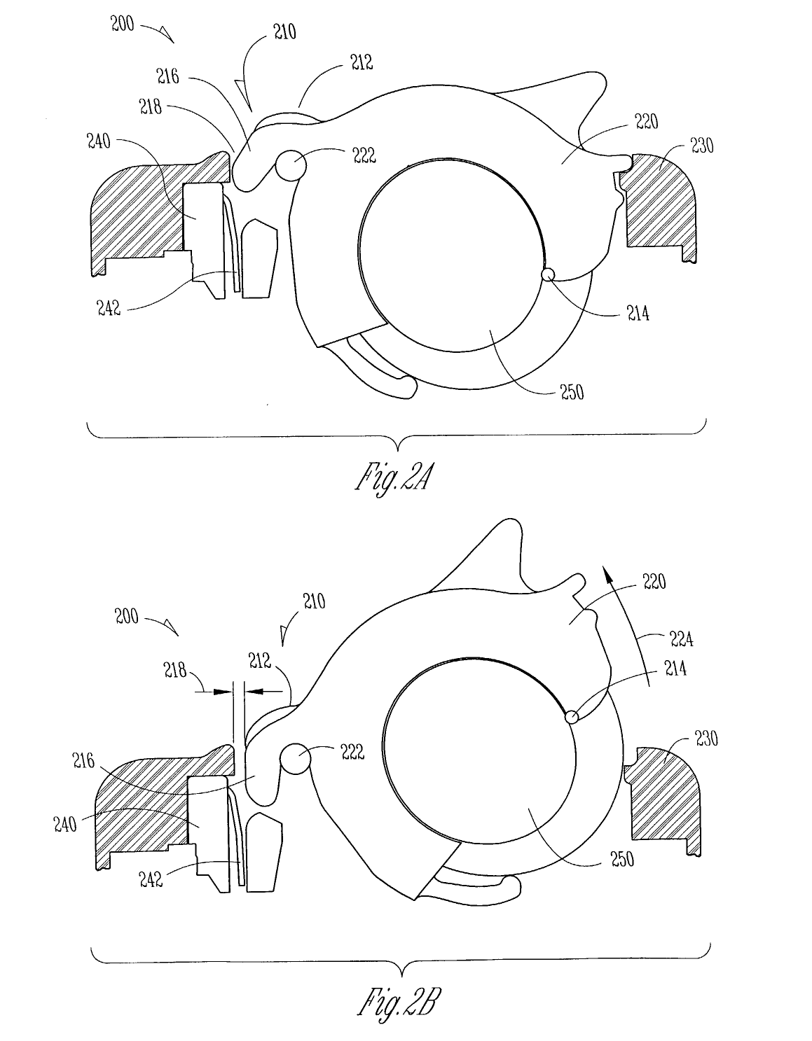

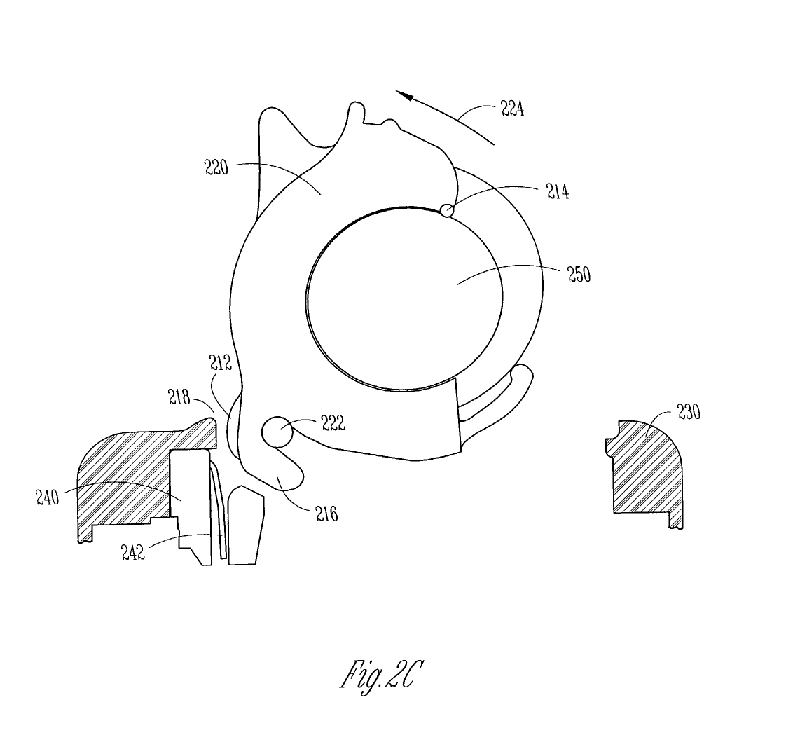

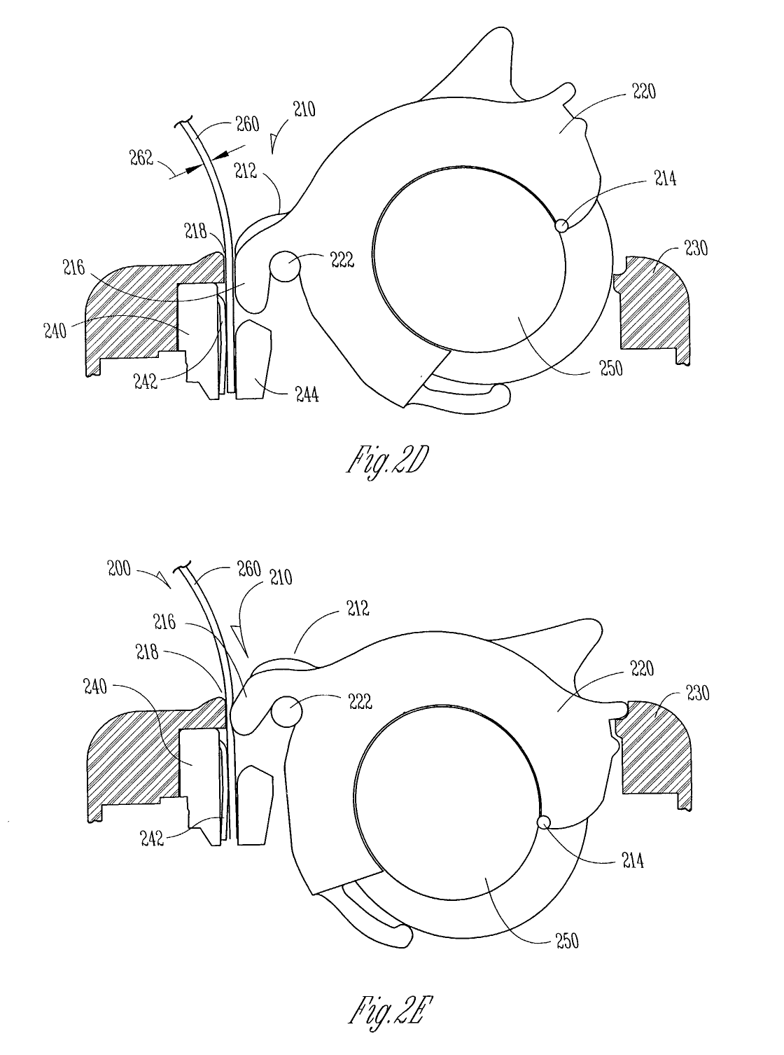

FIG. 2A shows a portion of a hearing aid 200. An interface actuator 210 is shown adjacent to a programming interface 240. In the embodiment shown, a battery door 220 is shown adjacent to the interface actuator 210 with a battery 250 enclosed. Although the interface actuator 210 is adjacent to the battery door 220 in FIG. 2A, other locations of the interface actuator 210 on a hearing aid are also within the scope of the invention. The battery door 220 is shown mating with a housing portion 230. The housing portion 230 also provides a mounting surface for other elements such as the programming interface 240. The embodiment shown in FIG. 2A includes an interface actuator 210 with a first portion 212 and a second portion 216. The first portion 212, the second portion 216 and the battery door 220 all rotate about a door pivot 222 in one embodiment as shown in FIG. 2A.

In one embodiment, the interface actuator 210 is attached to the battery door 220 and actuates simultaneously with the battery door 220. This design is advantageous for a number of reasons. One reason is because it is easy to manufacture. Separate actuation devices for the interface actuator 210 and the battery door 220 are not necessary due to the consolidation. In one embodiment the interface actuator 210 and the battery door are integrally molded together in a process such as injection molding. Although injection molding is used as an example, other manufacturing processes are also acceptable. Integral formation of the interface actuator 210 with the battery door 220 is also advantageous for manufacturing costs. The interface actuator can in this way be included in a hearing aid design by merely changing the mold of the battery door 220. While there are advantages to attaching the interface actuator 210 to the battery door 220 and integrally molding the interface actuator 210 with the battery door 220, it will be appreciated by one skilled in the art, having the benefit of the present disclosure, that other embodiments using separate interface actuators 210 are also within the scope of the invention.

The interface actuator 210 in FIG. 2A is shown in as first state of actuation. An insertion location 218, in the first state of actuation, is shown in a “closed” state where any gap, or opening to the programming interface 240 has been substantially blocked. As shown in FIG. 2A, in the first actuation state, the second portion 216 is primarily responsible for blocking any gap, or opening to the programming interface 240.

FIG. 2B shows the interface actuator 210 in a second actuation state. As previously discussed, one embodiment of the interface actuator is attached to the battery door 220 and actuated simultaneously with the battery door 220. In FIG. 2B, the battery door has been rotated in direction 224, about the door pivot 222 to a second state which in turn has moved the interface actuator to a second actuation state. The insertion location 218 now includes a gap that allows insertion of an external element such as a data transmission line (not shown). The second portion 216 has been rotated to allow the gap at the insertion location 218 to form. The first portion 212 has also rotated to a new position. In the second actuation state, the first portion 212 provides a gap at the insertion location 218 that allows insertion of a data transmission line. In the second actuation state, the first portion 212 further guides an object such as a data transmission line into the programming interface 240. In one embodiment, the guiding function of the first portion 212 is accomplished by providing a gap at the insertion location 218 with a close tolerance fit with the data transmission line that prohibits mis-alignment of the data transmission line.

An indicator device is further included in one embodiment to indicate an actuation state of the interface actuator 210. In the embodiment shown in FIG. 2B, the indicator device includes an indicator mark 214. In one embodiment, the indicator mark 214 can be aligned with another feature of the hearing aid to indicate a position along a range of motion of the interface actuator 210. In the embodiment shown, as discussed above, the interface actuator is attached to the battery door 220. When the battery door 220 is rotated along a range of motion 224, the indicator mark 214 can be aligned with the housing portion 230 to show a particular actuation state of the interface actuator 210. In one embodiment, when the indicator mark 214 is aligned with the housing portion 230, the interface actuator 210 is in a second state of actuation as described above. In one embodiment, the indicator mark indicates when the battery door has been rotated open approximately 14 degrees.

In one embodiment the indicator mark 214 includes a protruding bump. The protrusion serves as both a visual and a mechanical indicator of the actuation state of the interface actuator 210. As a protrusion, the indicator mark 214 can both be seen when it is in alignment with a feature such as the housing portion 230, and at the same time, the actuation state of the interface actuator 210 can be mechanically felt once the protrusion is outside the housing portion 230. For example, when rotated back towards the housing portion, the indicator mark 214 will provide friction as an interference fit once the protrusion is in alignment with the housing portion.

One skilled in the art, having the benefit of the present disclosure, will recognize that a plurality of indicator marks would also be acceptable. In one embodiment, the indicator mark 214 is integrally molded with the battery door 220. In further embodiments, the indicator mark could be attached to the housing portion instead of the battery door. Other mechanically detectable features such as a depression, etc. could be used in place of the protruding bump shown in FIG. 2B. Additionally, although a rotational motion is discussed above as actuating the battery door 220 and the interface actuator 210, other types of ranges of motion are also contemplated, such as linear, etc.

FIG. 2C shows the interface actuator 210 moved further in a range of motion than is illustrated in FIG. 2B. As previously discussed, one embodiment of the interface actuator is attached to the battery door 220 and actuated simultaneously with the battery door 220. In FIG. 2C, the battery door has been further rotated in direction 224, about the door pivot 222 to another position which in turn has moved the interface actuator to an alternative second actuation state. In one embodiment, in the alternative second actuation state, the first portion 212 again provides a gap at the insertion location 218 that allows insertion of a data transmission line. Similar to FIG. 2B, in the alternative second actuation state, the first portion 212 further guides an object such as a data transmission line into the programming interface 240. In one embodiment, the guiding function of the first portion 212 is accomplished by providing a gap at the insertion location 218 with a close tolerance fit with the data transmission line that prohibits mis-alignment of the data transmission line.

In one embodiment, the first portion 212 provides a close tolerance gap at the insertion location 218 throughout a guiding range of motion. In one embodiment, the guiding range of motion is between approximately 14 degrees and 90 degrees of rotation of the battery door. Two possible locations within the guiding range of motion are illustrated in FIGS. 2B and 2C, each defining a second actuation state of the interface actuator 210. In one embodiment, when the battery door is closed, or between approximately zero and 14 degrees, the interface actuator 210 is in a first state. In one embodiment the arcuate profile of the arcuate lobes of the first portion 212 provide a substantially constant gap width at the insertion location 218 throughout the guiding range of motion. A number of conditions in addition to those illustrated in FIGS. 2B and 2C that comply with the definition of a second state are therefore included within the guiding range of motion.

FIG. 2D shows the interface actuator 210 in one possible second actuation state. The insertion location 218 includes a gap as provided by the first portion 212 and the second portion 216 as discussed above. A data transmission line 260 is shown inserted through the interface actuator 210 into the programming interface 240. In one embodiment, the data transmission line 260 includes an electrical transmission line. As discussed above, other data transmission lines such as optical transmission, etc. are also contemplated. In one embodiment, the data transmission line 260 includes a flex strip with a number of flexible electrical trace lines. When inserted into the programming interface 240, the electrical trace lines make contact with the number of data contacts 242. In one embodiment, the data contacts 242 provide a spring force to press the data transmission line 260 against a back plate 244. With the data transmission line 260 inserted, the data contacts 242 thus are placed in communication with the trace lines, or similar structure, on the data transmission line 260.

FIG. 2E shows an embodiment of the interface actuator 210 returned to a first actuation state after insertion of the data transmission line 260 into the programming interface 240. In one embodiment, although the second portion 216 substantially prohibits insertion of the data transmission line 260 in the first state, if the data transmission line 260 has previously been inserted in a second state, the second portion 216 further provides a retention force. As shown in FIG. 2E, the second portion 216 now provides an interference fit with the data transmission line 260 and presses it against the housing portion 230. The retention force provided by the interference fit works along with the spring force provided by the data contacts 242 to further hold the data transmission line 260 in place during programming.

Conclusion

Thus devices and methods have been shown that provide a programming interface for a hearing aid that is easier to use, and more reliable to operate. Devices and methods have also been shown that are inexpensive to manufacture and more reliable than current designs.

Advantageously, in any one of the possible second actuation states, the interface actuator 210 guides the data transmission line 260 into the programming interface 240. The first portion 212 and the second portion 216 provide a close tolerance gap that is only spaced large enough to guide the data transmission line 260 correctly into place. In one embodiment, the gap provided at the insertion location 218 as defined by the first portion 212 and the second portion 216. In one embodiment, if the interface actuator 210 is in a first state, the data transmission line 260 is substantially prohibited from accessing the programming interface 240. Incorrect insertion of the data transmission line 260 and possible resulting damage to the data transmission line 260 is thereby minimized by prohibiting insertion in certain states of the interface actuator 210.

In one embodiment, if the data transmission line 260 is first inserted in a second actuation state, the battery door can subsequently be closed, and the second portion 216 provides a retention force that acts on the data transmission line 260. Configurations described above have an advantage of allowing the battery 250 to remain present in its normal location during programming. Power can therefore be provided to the hearing aid during programming.

Although specific embodiments have been illustrated and described herein, it will be appreciated by those of ordinary skill in the art, with the benefit of having read the present specification, that any arrangement which is calculated to achieve the same purpose may be substituted for the specific embodiment shown. This application is intended to cover any adaptations or variations of the present invention. It is to be understood that the above description is intended to be illustrative, and not restrictive. Combinations of the above embodiments, and other embodiments will be apparent to those of skill in the art upon reviewing the above description. The scope of the invention includes any other applications in which the above structures and fabrication methods are used. The scope of the invention should be determined with reference to the appended claims, along with the full scope of equivalents to which such claims are entitled.

What is claimed is:

1. A programming interface for a hearing aid, comprising:
at least one interface contact;
an interface actuator that is movable through a range of motion, the range including:
a first state, wherein the interface actuator substantially prohibits insertion of a programming data transmission line in the first state; and
a second state, wherein the interface actuator guides the programming data transmission line to the interface contact in the second state.

2. The programming interface of claim 1, wherein the interface actuator is located on a hearing aid battery door.

3. The programming interface of claim 2, wherein the battery door is substantially closed in the first state, and the battery door is at least partially open in the second state.

4. The programming interface of claim 2, wherein the battery door is substantially closed in the first state, and the second state is included in an guiding range of positions wherein the interface actuator guides the programming data transmission line to the interface contact throughout the range of positions.

5. The programming interface of claim 2, wherein the interface actuator is integrally formed with the hearing aid battery door.

6. The programming interface of claim 1, wherein the data transmission line includes a substantially flat flexible circuit strip.

7. The programming interface of claim 1, wherein the interface actuator includes:
a first portion that pivots about an actuator axis between the first and second states, the first portion substantially blocking access to the interface contact in the first state; and
a second portion that pivots about the actuator axis between the first and second states, wherein the second portion guides the programming data transmission line to the interface contact in the second state.

8. The programming interface of claim 7, wherein the first portion and the second portion are integrally formed with a hearing aid battery door.

9. The programming interface of claim 8, wherein the hearing aid battery door pivots about a hinge axis that is coaxial with the actuator axis.

10. The programming interface of claim 9, wherein the battery door is substantially closed in the first state, and the second state is included in a guiding range of positions wherein the interface actuator guides the programming data transmission line to the interface contact throughout the range of positions.

11. The programming interface of claim 10, wherein the guiding range of positions is between approximately 14 degrees and 90 degrees of rotation of the battery door.

12. The programming interface of claim 1, wherein the first state of the interface actuator further supplies a programming data transmission line retention force.

13. A method for programming a hearing aid, the hearing aid having a programming interface, comprising:
actuating an interface actuator from a first state that substantially prohibits insertion of a programming data transmission line, to a second state that guides the programming data transmission line to the programming interface;
inserting the programming data transmission line into the programming interface; and
transmitting data to the hearing aid through the data transmission line.

14. The method of claim 13, wherein actuating the interface actuator includes actuating a battery door wherein the programming interface guide is coupled to the battery door.

15. The method of claim 13, wherein actuating the interface actuator includes rotating a portion of the interface actuator including an arcuate guide portion of the interface actuator.

16. The method of claim 13, further including returning the interface actuator to the first state, wherein the interface actuator applies a retaining force to the programming data transmission line.

17. The method of claim 16, wherein a battery remains in place during transmitting of data to the hearing aid.

18. A hearing aid, comprising:
a hearing aid operation circuit;
a battery, operatively coupled to the hearing aid operation circuit;
a battery door that is moveable in a range of motion, including a first state and a second state;
at least one interface contact coupled to the hearing aid operation circuit;
an interface actuator coupled to the battery door, wherein:
the interface actuator substantially prohibits insertion of a programming data transmission line in the first state; and
the interface actuator guides the programming data transmission line to the interface contact in the second state.

19. The hearing aid of claim 18, wherein the battery door is substantially closed in the first state, and the battery door is at least partially open in the second state.

20. The hearing aid of claim 19, wherein the second state is included in a guiding range of positions wherein the interface actuator guides the programming data transmission line to the interface contact throughout the range of positions.

21. The hearing aid of claim 18, wherein the interface actuator is integrally formed with the battery door.

22. A method of forming a programming interface for a hearing aid, comprising:
forming at least one interface contact;
coupling an interface actuator adjacent to the at least one interface contact, the interface actuator being switchable in a range of motion, the range including:
a first state, wherein the interface actuator substantially prohibits insertion of a programming data transmission line in the first state; and
a second state, wherein the interface actuator guides the programming data transmission line to the interface contact in the second state.

23. The method of claim 22, wherein coupling the interface actuator adjacent to the at least one interface contact includes coupling an interface actuator to a battery door.

24. The method of claim 23, wherein coupling the interface actuator to the battery door includes integrally forming an interface actuator with a battery door.

25. The method of claim 24, wherein the battery door is substantially closed in the first state and the second state is included in a guiding range of positions wherein the interface actuator guides the programming data transmission line to the interface contact throughout the range of positions.
